(19) United States
(12) Patent Application Publication
(10) Pub. No.: US 2002/0152868 A1
(43) Pub. Date: Oct. 24, 2002

(54) Die retention pallet for material cutting devices

(76) Inventors: David Benes, Fremont, CA (US); Kelly Benes, Fremont, CA (US)

Correspondence Address: THOMTE, MAZOUR & NIEBERGALL, L.L.C., 2120 S. 72ND STREET, SUITE 1111, OMAHA, NE, 68124, US

(21) Appl. No.: 10/127,981

(22) Filed: Apr. 22, 2002

Related U.S. Application Data
(63) Continuation of application No. 09/758,769, filed on Jan. 11, 2001.
Application No. 09/758,769 is a continuation of application No. 09/124,654, filed on Jul. 29, 1998, now abandoned.

(51) Int. Cl. B26D 1/56; B26D 5/20

(52) U.S. Cl. 83/531; 83/533; 83/685

(57) ABSTRACT

A combination of a die retention pallet and a material cutting device for cutting material using blade-cut dies includes the device having a base, a pressing device mounted on and spaced from the base operative to exert force towards the base, and a pressing device engager operative to engage the pressing device and thereby drive the pressing device to exert force towards the base and the die retention pallet. The die retention pallet includes an open-top box having a base wall and at least two opposite side walls mounted on and extending upwards from the base wall, the die retention pallet dimensioned to fit within the material cutting device between the base and the pressing device of the material cutting device. The present invention also includes a die cover lid operative to cover a blade-cut die supported on the base wall of the die retention pallet. Finally, the die retention pallet is placed between the pressing device and the base of the material cutting device such that upon the pressing device engager engaging the pressing device thereby driving the pressing device to exert force towards the base, the pressing device engages the die cover lid which has been placed over a blade-cut die thereby forcing the die cover lid into contact with a blade-cut die supported on the base wall of the die retention pallet whereby material to be cut sandwiched between the die cover lid and a blade-cut die is cut in a shape designated by the blade-cut die.

### CROSS-REFERENCE TO RELATED APPLICATION

This is a continuation application of Petitioners' earlier application Ser. No. 09/758,769 filed Jan. 11, 2001, entitled DIE RETENTION PALLET FOR MATERIAL CUTTING DEVICES, which is a continuation application of Petitioners' earlier application Ser. No. 09/124,654 filed Jul. 29, 1998, entitled DIE RETENTION PALLET FOR MATERIAL CUTTING DEVICES.

### BACKGROUND OF THE INVENTION

1. Field of the Invention

The present invention relates to a die retention device and more particularly to a die retention pallet for material cutting devices which includes a generally rectangular open-topped metal box structure having a pivotably mounted pallet cover constructed of a urethane rubber compound having memory, the pallet designed to accept and hold therewithin blade-cut dies such that paper or other material to be cut may be sandwiched between the blade-cut die and the pivotably mounted lid, the pallet then being passed through a press-type material cutting device thereby cutting the material in the desired shape.

2. Description of the Prior Art

There are numerous devices presently being used which are capable of cutting shapes and designs, such as letters, numbers, or other such designs, out of various materials such as construction-type papers, fabrics, sponges, rubber, and other materials. These devices satisfy demands which arise generally from two major markets; the educational market, such as schools and pre-schools, and the craft and hobby market. The uses for such devices in the educational market are obvious, and would include the cutting out of large numbers and letters from construction paper for use in classroom decorations to facilitate the teaching of those letters and numbers. The craft market expands upon the possible uses for the material cutting devices to include the cutting of fabric, leathers, and other materials into various shapes for production of “knickknacks” and other craft items.

Various machines are presently used in the market for the cutting of such designs and shapes, including units manufactured by ACCUCUT, ELLISON and FREMONT MACHINE AND TOOL. These devices each generally fulfill the intended purpose of cutting material with a blade-cut die, but each of the machines does so in a slightly different manner. For example, the Ellison device consists of a press-type device having a long handle, the lower face of the upper section of the press contacting the material to be cut or a rigid cover piece and pressing the material to be cut down onto the blade-cut die thus cutting the material. The Accucut device, on the other hand, uses a stationary press roller which, when rotated, causes a blade-cut die movably supported on a tray to travel thereunder. As the die passes under the roller, the paper is pressed down onto the blade-cut die thus cutting the design into the paper.

The major problem encountered with the use of the blade-cut dies with either the Ellison or Accucut machines is that the dies often slip when being used, resulting in degradation of the design being cut from the material. Neither the Accucut nor Ellison machines are designed to correct this problem, and therefore there is a need for a device which will substantially prevent slippage and/or movement of the blade-cut dies during the press process.

Briefly, a standard blade-cut die is constructed as having a wooden rectangular base block approximately three-quarters of an inch thick into which are secured a plurality of razor blades extending vertically upwards from the upper surface of the wooden block. The razor blades are arranged to form a design such as a letter, number or other such shape with the cutting edge of each razor blade at the upper edge thereof. Surrounding the razor blades and extending slightly (one-sixteenth of an inch) above the cutting surface of each razor blade is a block of foam rubber which prevents a user of the blade-cut die from accidentally cutting himself or herself when handling the blade-cut die. The foam rubber deforms downwards when pressure is applied thereto, thus exposing the cutting surface of the razor blades and cutting the appropriate design from the material placed onto the blade-cut die. Of course, other designs of dies are currently available, but the present description applies to the most common type of blade-cut die used in the educational and craft fields.

In both educational and craft fields, reduction of waste is an important consideration. However, it is most important in the educational field where many schools are running on tight budgets and construction paper and other such materials can be somewhat expensive. Therefore, there is a need for a die support pallet which will substantially eliminate wasted paper caused by slippage of the die within the material cutting device which renders the cut-out design unusable.

### SUMMARY OF THE INVENTION

The present invention provides, in combination, a material cutting device for cutting material using blade-cut dies and a die retention pallet, the material cutting device including a base, a pressing device mounted on and spaced from the base operative to exert force towards the base and a pressing device engager operative to engage the pressing device and thereby drive the pressing device to exert force towards the base. The die retention pallet includes an open-top box having a base wall and at least two opposite side walls mounted on and extending upwards from the base wall, the die retention pallet dimensioned to fit within the material cutting device between the base and the pressing device of the material cutting device. The present invention also includes a die cover lid operative to cover a blade-cut die supported on the base wall of the die retention pallet. Finally, the die retention pallet is placed between the pressing device and the base of the material cutting device such that upon the pressing device engager engages the pressing device, thereby driving the pressing device downward to exert force towards the base. The pressing device engages the die cover lid which has been placed over a blade-cut die thereby forcing the die cover lid into contact with a blade-cut die supported on the base wall of the die retention pallet whereby material to be cut sandwiched between the die cover lid and a blade-cut die is cut in a shape designated by the blade-cut die.

The combination described above clearly provides numerous advantages over the operation of those devices found in the prior art. For example, because the blade-cut die is supported within the die retention pallet and is not merely free-standing, there is much less likelihood of the blade-cut die slipping relative to the material being cut, therefore greatly reducing wasted material. Furthermore, the die cover lid is preferably constructed of a deformable urethane rubber compound which has memory such that when the blades of the blade-cut die extend slightly into the lid, the urethane compound causes the indentations and/or cuts formed in the die cover to reseal to a great extent, thus increasing the useable lifespan of the die cover. Also, the die retention pallet can be used with material cutting devices already being used in the educational and commercial fields, thus addressing and resolving the potential problem of incompatibility.

A principal object of the present invention is to provide a die support pallet for use in a material cutting device.

Another object of the present invention is to provide a die support pallet for use in a material cutting device which includes a generally rigid open-top box having a flat base and four generally upright side walls and a moveable lid preferably mounted thereon, the lid constructed of a semi-rigid material capable of deforming slightly under pressure exerted by a material cutting device thereon.

Another object of the present invention is to provide, in combination, a material device including a base, a pressing device mounted on the base operative to exert downwards force, and an engagement device to engage the press device to cause the press device to exert downwards force, the material cutting device being used with the pallet described in the previous paragraph.

Another object of the present invention is to provide a die support pallet in which the lid is constructed of a deformable urethane rubber compound which has memory such that when the blades of the blade-cut die extend slightly into the lid, the urethane compound causes the indentations and/or cuts formed in the die cover to reseal to a great extent, thus increasing the useable lifespan of the die cover.

Another object of the present invention is to provide a die support pallet which will substantially prevent movement of the blade-cut die supported therein thereby greatly decreasing waste due to improper cutting of material being cut between the blade-cut die and lid of the die support pallet.

Yet another object of the present invention is to provide a die support pallet for use with a material cutting device which is relatively simple to manufacture and is safe, efficient, and durable in use.

These and other objects will be apparent to those skilled in the art.

### BRIEF DESCRIPTION OF THE DRAWINGS

FIG. 1 is a perspective view of the die retention pallet of the present invention showing a blade-cut die supported therein and further showing a design having been cut from the material;

FIG. 2 is a detail side elevational view of the present invention showing the pivotable connection of the lid and box;

FIGS. 3, 4 and 5 are perspective views of the die retention pallet of the present invention being used with various examples of material cutting devices presently being used in the field; and

FIG. 6 is a perspective view of an alternative embodiment of the die retention pallet being used with a modified Accucut-type device.

### DESCRIPTION OF THE PREFERRED EMBODIMENT

The die support pallet 10 of the present invention is shown best in FIGS. 15 as including a generally rectangular open-top box 12, and a lid 50 which is preferably movably mounted on the box 12. In the preferred embodiment, rectangular box 12 would include a generally flat base plate 14 and at least three generally upright side walls 16a, 16b, and 18. It is preferred that rectangular box 12 be constructed of a sturdy metal, preferably a brushed aluminum for structural strength and weight reduction. Furthermore, although box 12 is described as being rectangular in shape, it is to be understood that the precise shape of the box 12 is not critical to the present invention so long as the function of blade-cut die retention is performed. In the embodiment shown in FIG. 1, the general dimensions of the rectangular box 12 would be approximately twelve inches in length along side wall 16a, ten inches along end wall 18 and a height of approximately one inch. Base plate 14 would preferably have a thickness of approximately one-thirty-second to one-quarter inches and the thickness of side wall 16a and 16b and end wall 18 would be approximately one-half inch. In this manner, the internal dimensions of rectangular box 12 would be approximately eleven inches by nine inches, which will accommodate most if not all of even the largest blade-cut dies manufactured presently.

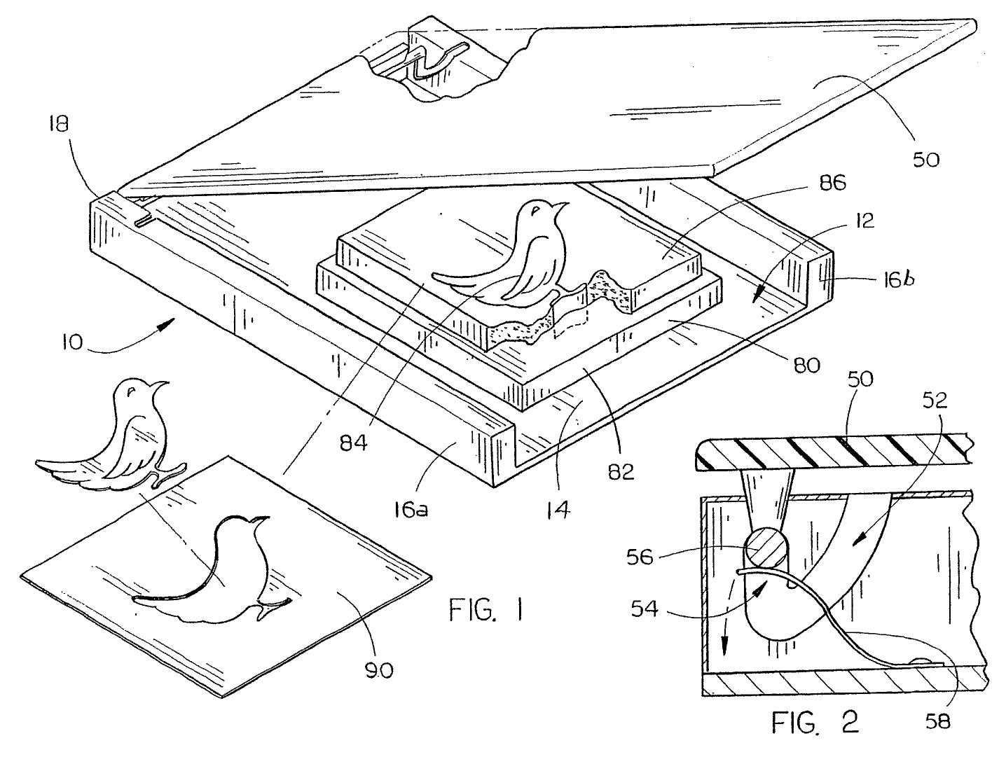

As shown best in FIGS. 1 and 2, the die cover lid 50 is mounted on the rectangular box 12 with side walls 16a and 16b each further including a sloped channel 52 which ends in a receiving pocket 54, as shown best in FIG. 2. A rod 56 is mounted to the underside of die cover lid 50, rod 56 having a length slightly greater than the distance between the inside surfaces of side walls 16a and 16b such that the ends of rod 56 extend into side walls 16a and 16b. The ends of rod 56 may thus be slid into the sloped channel 52 and then moved upward into the retention pocket 54 where the ends of rod 56 are releasably retained therein by a leaf spring 58 or the like. The die cover lid 50 is thus pivotably and removable mounted on the rectangular box 12, as shown in FIGS. 1 and 2. The die cover lid 50 may be mounted on the rectangular box 12 in any appropriate manner, or may even be left unconnected to the box 12, so long as the functionality of lid 50 is not affected.

It is further preferred that die cover lid 50 be constructed of a urethane rubber compound which has memory, meaning that the indentations and/or cuts which are formed in the die cover lid 50 as a result of partial razor blade insertion will eventually reseal to a great extent, thus increasing the usable lifespan of the die cover lid 50. Also, it is preferred that the dimensions of die cover lid 50 be approximately eleven inches by nine inches to fit within the rectangular box 12. It is to be understood that the die cover lid 50 of the present invention may be smaller or larger depending on the blade-cut die which is to be covered. In fact, it is not necessary for the die cover lid 50 to be mounted on the rectangular box 12 at all, as the die cover lid 50 may be merely placed over the material to be cut and the blade-cut die.

FIG. 1 best shows how a blade-cut die 80 would be supported within the die support pallet 10. The base block 82 of blade-cut die 80 would rest on base plate 14 of rectangular box 12 with the blades 84 of the blade-cut die 80 extending upwards therefrom encased in the foam rubber 86. Although FIG. 1 shows a single blade-cut die 80 placed within the die support pallet 10, one of the unique features of the present invention is that the die support pallet 10 may accommodate multiple blade-cut dies at the same time which not only speeds the cutting process but can help to reduce waste as multiple figures may be cut out of a single sheet of paper.

Once the blade-cut die 80 is placed within the die support pallet 10, the die cover lid 50 is closed over the blade-cut die 80. Of course, the material 90 which is to be cut (shown in FIG. 1 as a sheet of paper) would be placed on top of the blade-cut die 80 and underneath the die cover lid 50 so that the material 90 is sandwiched between the blade-cut die 80 and die cover lid 50.

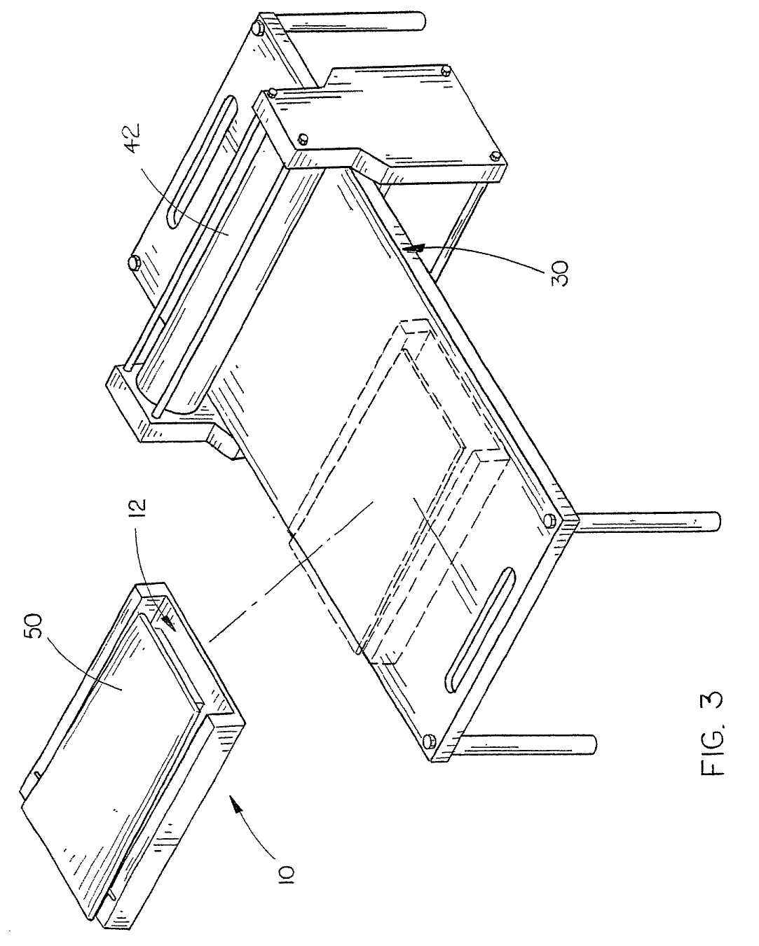

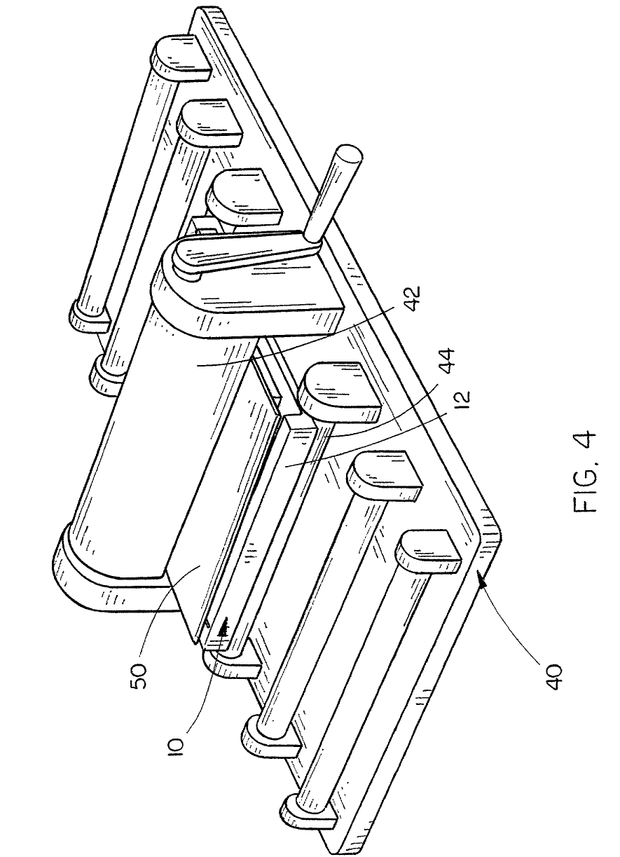

The height of the blade-cut die 80 as measured from the bottom of base block 82 to the top of razor blades 84 is approximately one-quarter inch to one-half inch above the height of the top walls of side walls 16a and 16b so that the die cover lid 50 rests upon the material 90 which is to be cut and the blade-cut die 80. The die support pallet 10 is thus ready for use with a material cutting device such as those shown in FIGS. 3-5.

Each of the material cutting devices shown in FIGS. 3-5 include some means of exerting downwards force on die cover lid 50 of die support pallet 10 in order to force the material 90 down onto blade-cut die 80, thus forcing razor blades 84 up through material 90 and cutting the design therefrom. In the cutting device 30 of FIG. 3, a press roller 42 is moved over the die support pallet 10 such that the press roller 42 engages the die cover lid 50. As the press roller 42 is moved over the die support pallet 10, die cover lid 50 is forced downwards thereby forcing material 90 downwards onto blade-cut die 80 whereby razor blades 84 extend upwards through material 90 thus cutting the design therefrom as shown in FIG. 1.

The cutting device 40 of FIG. 4 is similar in design to the product manufactured by Accucut and incorporates the stationary rotatable press roller 42. The die support pallet 10 is placed on base rollers 44 of the device 40 and the press roller 42 is rotated to draw the die support pallet 10 from one side of the press roller 42 to the other. As the die support pallet 10 is moved underneath the press roller 42, once again the die cover lid 50 is forced downwards, thus pressing material 90 downward onto blade-cut die 80 so that razor blades 84 extend upwards through the material 90 thus cutting the design therefrom.

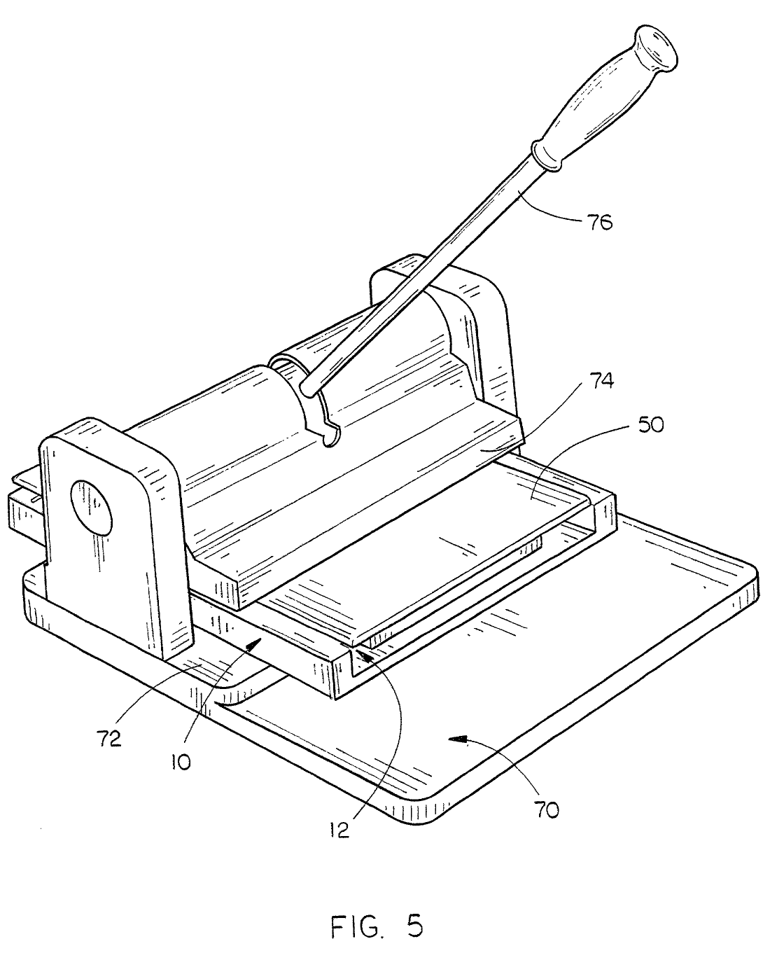

Finally, the cutting device 70 of FIG. 5 is shown as similar to that presently manufactured by Ellison, the cutting device 70 including a base plate 72, press plate 74 and the pressing handle 76 operative to move press plate 74 downwards towards base plate 72. Die support pallet 10 is slid in between the base plate 72 and press plate 74 and when press plate 74 is moved downwards by activation of press handle 76, die cover lid 50 is pressed downwards to move material 90 downwards onto blade-cut die 80 thereby forcing the razor blades 84 to extend upwards through material 90 cutting the material 90 in the desired design.

In each of the three cutting devices and methods of use thereof described above, the ease of use of the die support pallet 10 is clearly related, but what may not be so clear at first glance is what should be recognized as one of the most important features of the die support pallet 10. One of the major problems encountered with use of the material cutting devices presently available is that as the cutting devices are being used, there is a tendency for the blade-cut die 80 to shift underneath the various pressing devices thereby degrading the quality of design being formed as the material 90 is being cut and possibly rendering the design useless, thereby wasting the material 90. Furthermore, it has oftentimes been found that in order to cut more than one sheet of material, the cutting device must be engaged multiple times to force the razor blades 84 entirely through the material 90 which is being cut. It is extremely common that the blade-cut die 80 and material 90 will shift during the multiple engagements of the cutting devices thus ruining the design being cut from the material 90. The die support pallet 10 of the present invention is specifically designed to prevent movement of the material 90 and blade-cut die 80 once the die cover lid 50 is closed over the blade-cut die 80. This is due to the integral structure of the die support pallet 10 wherein the rectangular box 12 and die cover lid 50 operate as a single unit and therefore when the position of the die support pallet 10 is changed, the relative locations of the blade-cut die 80, material 90, die cover lid 50, and rectangular box 12 do not change, thereby ensuring consistent and accurate cutting of the material 90 held within the die support pallet 10.

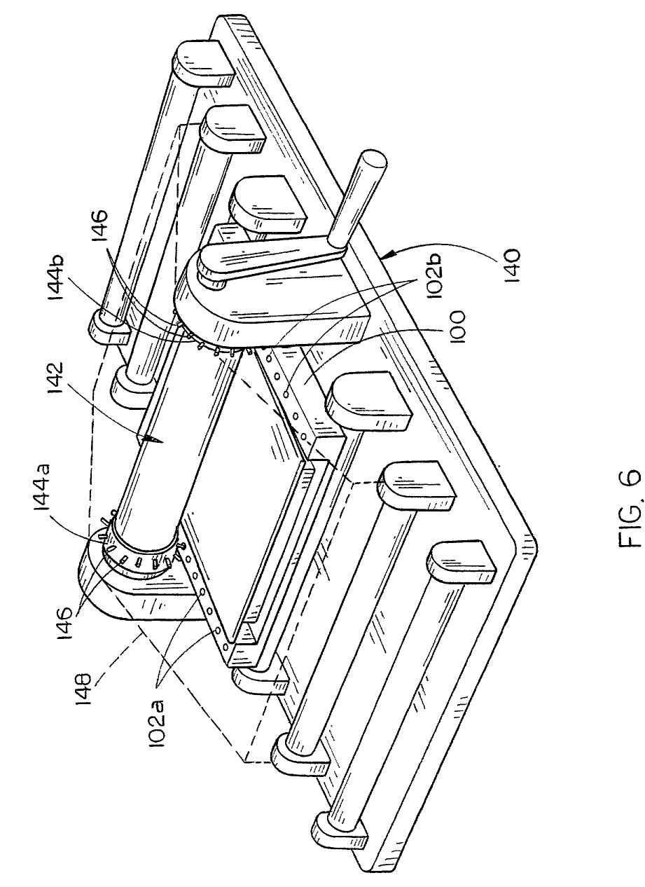

FIG. 6 shows a modified die support pallet 100 which includes a series of spaced-apart holes 102a and 102b formed in the side walls 16a and 16b of the pallet 100. The modifications include fixedly mounting two outer wheels 144a and 144b on the ends of press roller 142 each of which include radially projecting fingers 146 which are approximately one-half inch in length. The pallet 100 is modified to include two rows of finger-receiving holes 102a and 102b which are spaced to receive the fingers 146 of outer wheels 144a and 144b. The modified pallet 100 is fed through the modified press device 140 by sliding the pallet 100 under the outer wheels 144a and 144b such that the fingers 146 engage the finger-receiving holes 102a and 102b. As the press roller 142 rotates, outer wheels 144a and 144b likewise rotate, and as each of the fingers 146 engage the subsequent finger-receiving hole 102a and 102b, the pallet 100 is drawn through the device under the press roller, thus cutting the paper therein.

FIG. 6 also discloses cover 148 of the device 140, shown in dotted-line format, which is generally trapezoidal in cross section and is preferably constructed of an impact-resistant plastic or the like. Cover 148 is specifically designed to prevent the insertion of extremities (specifically fingers and hands) under the cover 148 of the modified “Accucut” press device 140 to prevent injury to the operator of the device. It is intended that only the pallet 100 be able to fit underneath the cover 148, and therefore injury will be prevented. The exact shape of the cover 148 and the construction materials used for the cover 148 are not critical to the invention so long as the primary function of the cover 148, that of prevention of injury, is fulfilled.

The modified device and pallet clearly provide a substantial improvement over the unmodified Accucut device in that to draw the pallet through the device 140, the fingers 146 of the outer wheels 144a and 144b and the finger-receiving holes 102a and 102b intermesh with the rotation of the wheels 144a and 144b, thus pulling the pallet 100 through the device without the risk of slippage of the pallet. The pallet 100 is thus uniformly drawn through the device 140, which will result in improved cutting of material by the device 140.

The die support pallet 10 of the present invention has been described as being designed for use in the craft and educational markets, and for use with the cutting devices presently used in those markets. It is to be understood, however, that by modifying the dimensions of the present invention and the construction materials, the pallet 10 could be used in numerous industrial areas such as the cutting out of gaskets from rubber, the cutting of shaped sponges for certain industrial uses and the cutting of plastics into desired shapes for various commercial uses. The use of die support pallet 10 would be substantially the same as previously described in connection with the cutting devices 30, 40, and 70, but the pallet may be modified for use with other types of press devices needed for the cutting of such industrial materials.

It should also be noted that the present invention could be used for embossing of material also. Briefly, the method of embossing a planar material such as paper would be as follows. A block of material having a raised design on the upper surface thereof is placed within the die support pallet 10 on the base plate 14 in place of a blade-cut die 80. The planar material to be embossed would then be placed on top of the block of material such that the planar material is in contact with the raised design. The die cover lid 50 would then be placed over the planar material as described previously in connection with the cutting of paper, and the pallet would then be inserted into a material cutting device. When force is applied to the die cover lid 50, the planar material is forced downwards onto the raised design, and the planar material deforms in the shape of the raised design. As the height of the raised design is generally less than one-fourth inch, the planar material merely deforms and retains the embossed design therein, instead of being cut by the raised design. A limitless number of designs and shapes may thus be embossed in planar material by use of the above-described process.

It is furthermore important to note that although the present invention is described as being used in connection with “material cutting devices,” such devices may be more accurately described as “material pressing devices,” for that is their true function. However, as such devices are used the majority of the time for the cutting of designs from planar material, the term “material cutting devices” is believed to be generally accurate. Therefore, although the present invention is described generally as being designed for use with blade-cut dies, embossing dies and any other press dies can be used with the present invention, referred to generally as material modifying dies, and thus it should be understood that whereas the claims refer generally to blade-cut dies being used with the present invention for clarity, many other types of dies and designs may be used with the present invention.

It is to be understood that numerous modifications, additions, and substitutions may be made to the die support pallet 10 of the present invention which fall within the broad scope of the appended claims. For example, the pallet 10 may be constructed of numerous types of materials or the dimensions set forth in the proceeding description may be modified or changed so long as the functionality of the invention is not affected. Furthermore, it may not strictly be necessary to include all four walls for the die support pallet 10, but it is preferred that the rectangular box 12 include four side walls for strength. Finally, as was stated previously, several blade-cut dies may be used underneath the die cover lid 50 of the present invention at the same time and the cutting process would remain substantially the same.

Thus it can be seen that the invention accomplishes at least all of its stated objectives.

We claim:

1. A die retention pallet, comprising:
a generally planar base wall having upper and lower surfaces and a peripheral edge portion; and
a generally planar die cover having an upper surface and a lower surface; said die cover being operatively hingedly connected to the peripheral edge portion of said base wall.

2. The die retention pallet of claim 1 wherein said die cover is comprised of a semi-rigid material, whereby indentations and cuts formed in said die cover will generally reseal to increase the usable life span of said die cover.

3. The die retention pallet of claim 1 further comprising at least one generally vertical wall extending upwardly from said base adjacent the peripheral edge portion thereof.

4. The die retention pallet of claim 3 wherein said die cover is operatively hingedly connected to said at least one generally vertical wall so that said die cover can be selectively moved between open and closed positions with respect to said base wall.

5. The die retention pallet of claim 1 further comprising at least two generally vertical walls extending upwardly from said base adjacent the peripheral edge portion thereof.

6. The die retention pallet of claim 4 wherein said die cover is operatively hingedly connected to said at least two generally vertical walls so that said die cover can be selectively moved between open and closed positions with respect to said base wall.

7. The die retention pallet of claim 6 wherein said two walls are oppositely disposed.

8. A die retention pallet, comprising:
a generally planar base wall having upper and lower surfaces and a peripheral edge;
a generally planar die cover having an upper surface and a lower surface; and
hinge means operatively connected to the peripheral edge of said base wall for operatively pivotably connecting said die cover to the peripheral edge of said base wall.

9. A die retention pallet of claim 7 wherein said hinge means allows said die cover to pivot between open and closed positions and move vertically with respect to said base wall.
